(19) United States
(12) Patent Application Publication
(10) Pub. No.: US 2007/0288956 A1
(43) Pub. Date: Dec. 13, 2007

(54) Method of tuning broadcast channel using virtual channel and broadcast-receiving device for the same

(75) Inventor: Chang-dae Bang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/703,180

(22) Filed: Feb. 7, 2007

(30) Foreign Application Priority Data
Mar. 7, 2006 (KR) 10-2006-0021510

(51) Int. Cl. H04N 5/44

(52) U.S. Cl. 725/38

(57) ABSTRACT

A method of tuning a broadcast channel using a virtual channel is provided. The method includes receiving a channel selection request and, if the requested channel is a virtual channel that includes information on a broadcast channel to be tuned by predetermined time slots, then tuning the broadcast channel according to the setting information of the virtual channel.

### CROSS-REFERENCE TO RELATED APPLICATION

This application claims priority from Korean Patent Application No. 10-2006-0021510 filed on Mar. 7, 2006, in the Korean Intellectual Property Office, the disclosure of which is incorporated by reference herein in its entirety.

### BACKGROUND OF THE INVENTION

1. Field of the Invention

Methods and apparatuses consistent with the present invention relate to tuning a broadcast channel. More particularly, methods and apparatuses consistent with the present invention relate to tuning a broadcast channel, using a virtual channel and a broadcast-receiving device for the same.

2. Description of the Related Art

A television station regularly broadcasts programs at specified days and times of the week. For example, drama series or news programs are broadcast at specified times on specified days of the week.

Typically, a viewer must remember the broadcast channel and the time of the broadcasting, and at the broadcast time, the user must choose the channel.

Likewise, according to the conventional art, a viewer must remember the broadcast information such as the broadcast time, days of the week, and the channel, which is inconvenient.

Japanese Patent Publication No. 2004-104815 (System and Method for Indicating Program Schedule Information on TV Channel) discloses a technology about an electronic program schedule system that receives program information, stores the program information in a memory, and indicates the stored program schedule and program information. However, the system and method disclosed in Japanese Patent Publication No. 2004-104815 only enables simple recognition of a broadcast program schedule by a user. Hence, the system and method disclosed therein is still inconvenient since the user must check the broadcast program schedule, and change the channel at a specific time.

### SUMMARY OF THE INVENTION

An aspect of the present invention makes broadcast scheduling and channel selection easy by using a virtual channel that can be set directly by the user.

The present invention will not be limited to the technical objects described above. Other objects will be readily understood by those skilled in the art from the following detailed description.

According to an exemplary embodiment of the present invention, there is provided a method of tuning a broadcast channel using a virtual channel, the method including receiving a channel selection request; and tuning the broadcast channel according to the setting information of the virtual channel if the requested channel is a virtual channel that includes information on a broadcast channel to be tuned in at predetermined times.

According to an exemplary embodiment of the present invention, there is provided a broadcast-receiving device including an input unit that receives a channel selection request, and a tuning unit that tunes the broadcast channel according to the setting information of the virtual channel if the requested channel is a virtual channel that includes information on a broadcast channel to be tuned in at predetermined times.

### BRIEF DESCRIPTION OF THE DRAWINGS

The above and other features and advantages of the present invention will become apparent by describing in detail exemplary embodiments thereof with reference to the attached drawings, in which:

FIG. 1 is a block diagram illustrating a broadcast-receiving device according to an exemplary embodiment of the present invention.

FIG. 2 illustrates setting information of a virtual channel according to an exemplary embodiment of the present invention.

FIG. 3 illustrates setting information of a virtual channel according to another exemplary embodiment of the present invention.

FIG. 4 illustrates setting information of a virtual channel according to a further exemplary embodiment of the present invention.

FIG. 5 is a flow chart illustrating a process of setting a virtual channel according to an exemplary embodiment of the present invention.

FIG. 6 is a flow chart illustrating a process of tuning a broadcast channel according to an exemplary embodiment of the present invention.

### DETAILED DESCRIPTION OF EXEMPLARY EMBODIMENTS OF THE INVENTION

Exemplary embodiments of the present invention will be described in detail with reference to the accompanying drawings.

Advantages and features of the present invention and methods of accomplishing the same may be understood more readily by reference to the following detailed description of the exemplary embodiments and the accompanying drawings. The present invention may, however, be embodied in many different forms and the present invention should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

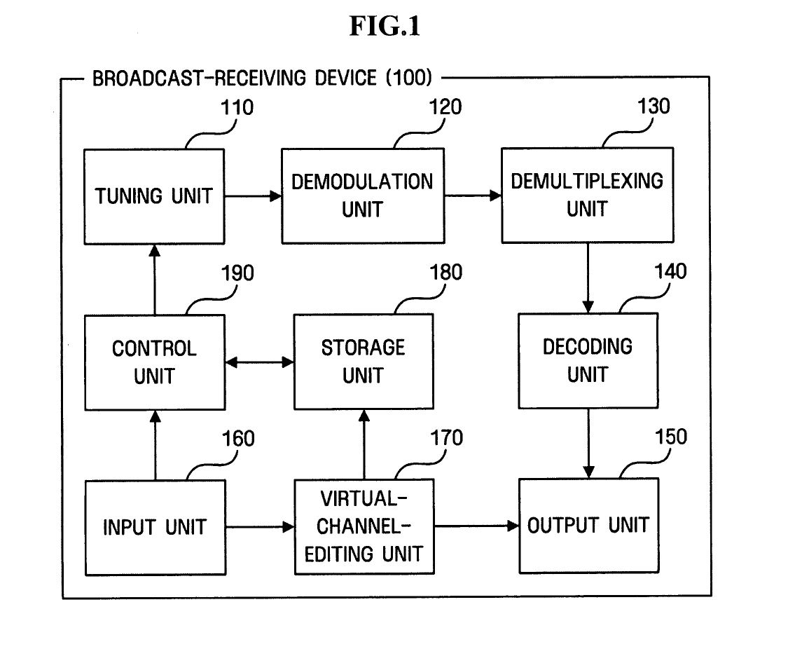

FIG. 1 is a block diagram illustrating a broadcast-receiving device according to an exemplary embodiment of the present invention. The illustrated broadcast-receiving device 100 includes a tuning unit 110, a demodulation unit 120, a demultiplexing unit 130, a decoding unit 140, an outputting unit 150, an input unit 160, a virtual-channel-editing unit 170, a storage unit 180, and a control unit 190. Such a broadcast-receiving unit 100 can be implemented as a set-top box, a digital TV, a mobile device or computer having a broadcast-receiving function, or other apparatuses.

The tuning unit 110 receives a broadcast signal of a predetermined channel through channel tuning, converts the received broadcast signal into an intermediate frequency, and sends it to the demodulation unit 120. For example, if the broadcast-receiving device 100 receives satellite broadcasting, the tuning unit 110 detects an I/Q signal from the signal received from a satellite, and provides the detected I/Q signal to the demodulation unit 120.

The demodulation unit 120 restores a transport stream from the intermediate frequency signal, and provides the restored transport stream to the demultiplexing unit 130. For example, the demultiplexing unit 120 can include a Quadratic Phase Shift Keying (QPSK) demodulator (not shown) and a Forward Error Correction (FEC) (not shown), by which the QPSK and FEC processing can be performed.

The demultiplexing unit 130 parses the transport stream transmitted from the demodulation unit 120, separates a video signal, an audio signal, and additional information from the transport stream, and provides them to the decoding unit 140.

The decoding unit 140 includes a video decoder (not shown) and an audio decoder (not shown). The video decoder decodes the video signal and the audio decoder decodes the audio signal provided from each demultiplexing unit 130. According to an exemplary embodiment, the video decoder can be implemented according to video-compressing methods such as MPEG-2 and MPEG-4, and the audio decoder can be implemented according to audio compression methods such as MPEG Layer-3 (MP3) and Audio Compression 3 (AC3). Further, the decoding unit 140 can decode an additional information signal, and the additional information signal can include metadata on a broadcasting program such as an Electric Program Guide (EPG).

The output unit 150 outputs a decoding result, which is received from the decoding unit 140, via a monitor or a TV, for example. The broadcast-receiving device 100 can include a predetermined display (not shown), and the output unit 150 can output the decoding result to the display. Further, the output unit 150 outputs a user interface provided by the virtual-channel-editing unit 170 via a monitor, a TV, or another display.

The input unit 160 receives a control request from a user, and transmits the request to the control unit 190. For the input, the input unit 160 can include an input device such as a keypad or a touch screen. Hence, the user can select a channel or edit a virtual channel through the input unit 160. According to the present exemplary embodiment, the user can input a control request by remote control, and in such a case, the input unit 160 can include an infrared (IR) receiver or a Radio Frequency receiver, which can receive a remote control signal.

The virtual-channel-editing unit 170 edits a virtual channel according to the request from a user. For this, the virtual-channel-editing unit 170 can provide a user interface that guides virtual-channel editing. According to this exemplary embodiment, the user-defined virtual channel is a channel to which one or more broadcast channels are mapped according to predetermined time slots. A channel number, which represents the virtual channel, is allocated to the virtual channel. For example, if the channel numbers mapped to regular broadcast channels are 1 to 100, the user can allocate channel numbers from 101, and above, to the virtual channel.

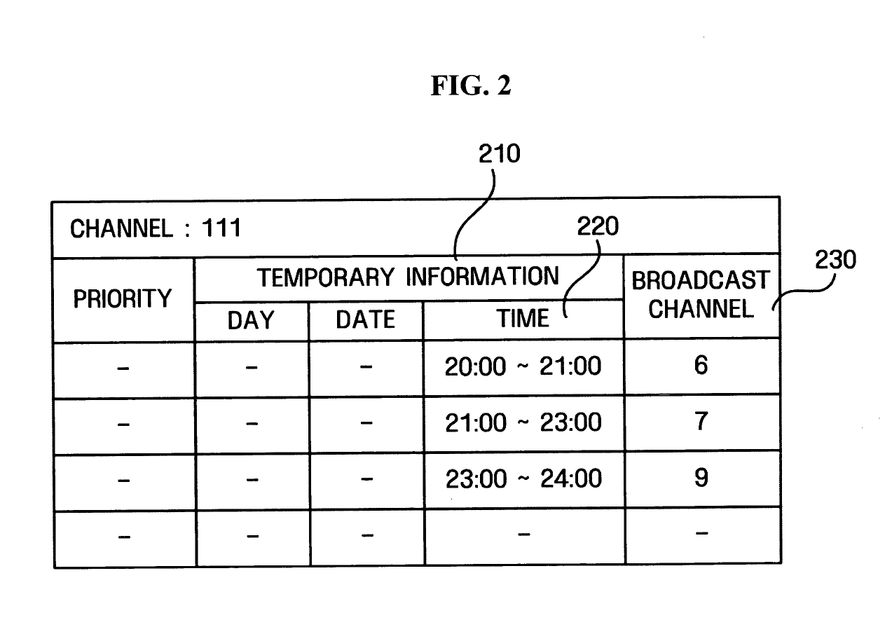

The virtual channel includes information about one or more broadcast channels and temporal information according to which broadcast channels included in the virtual channel can be tuned. According to the present exemplary embodiment, temporal information includes at least one of a day of the week, a date, and a time. The setting information of the virtual channel according to the present exemplary embodiment is illustrated in FIG. 2.

FIG. 2 illustrates setting information of a virtual channel according to an exemplary embodiment of the present invention. Referring to FIG. 2, channel 111 is allocated to a virtual channel, and the time information 220 is set as temporal information 210. Moreover, the virtual channel includes broadcast channel information 230 for tuning according to the set temporal information 210. The broadcast channel information 230 in the present exemplary embodiment is the channel number of the broadcast channel to be tuned according to the temporal information.

In the case where the virtual channel is set as illustrated in FIG. 2, if a user selects virtual channel 111, the broadcast channel corresponding to channel 6 is tuned to from 20:00 to 21:00, the broadcast channel corresponding to channel 7 is tuned to from 21:00 to 23:00, and the broadcast channel corresponding to channel 9 is tuned to from 23:00 to 24:00. The ways of utilizing remaining time slots in the virtual channel can be implemented in various ways. For example, for the remaining time slots from 00:00 to 20:00, it is possible that the broadcast channel corresponding to channel 9, which is the last channel, can be tuned to. As another example, for the remaining time slots, it is possible that no broadcast channel is tuned to even though channel 111 is selected.

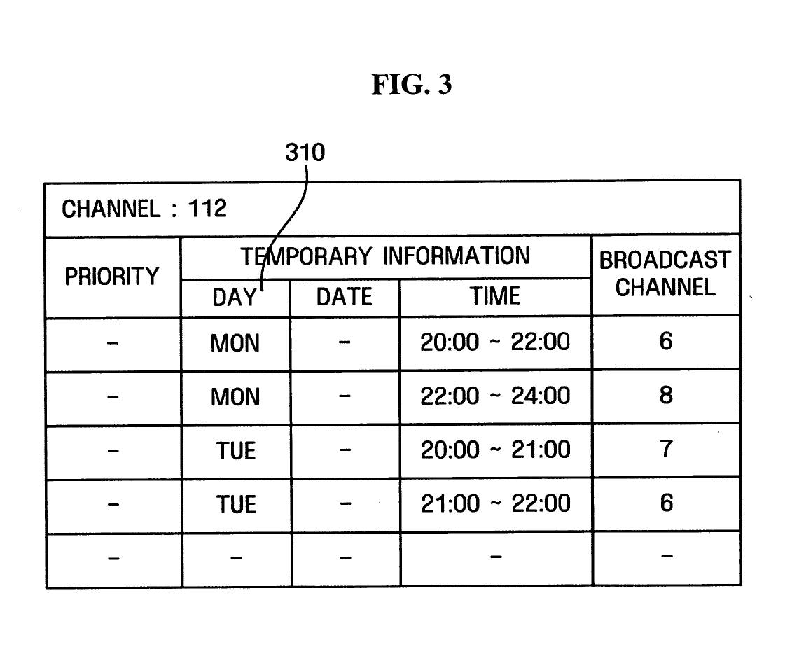

FIG. 3 illustrates setting information of a virtual channel according to another exemplary embodiment of the present invention. The illustrated virtual channel is allocated channel 112, and day-of-the-week information 310, as well as time information, is set as temporal information. As illustrated in FIG. 3, in the case where a virtual channel is set, if a user selects channel 112, the broadcast channel, which corresponds to channel 6, is tuned to from 20:00 to 22:00 every Monday, and the broadcast channel, which corresponds to channel 8, is tuned to from 22:00 to 23:00 every Monday. Further, the broadcast channel, which corresponds to channel 7, is tuned to from 20:00 to 21:00 every Tuesday, and the broadcast channel, which corresponds to channel 6, is tuned to from 21:00 to 22:00 every Tuesday. For the remaining time slots, in the case where channel 112 is selected, the virtual channel can be implemented in various ways.

Though not illustrated in FIG. 2 and FIG. 3, date information can be used as temporal information.

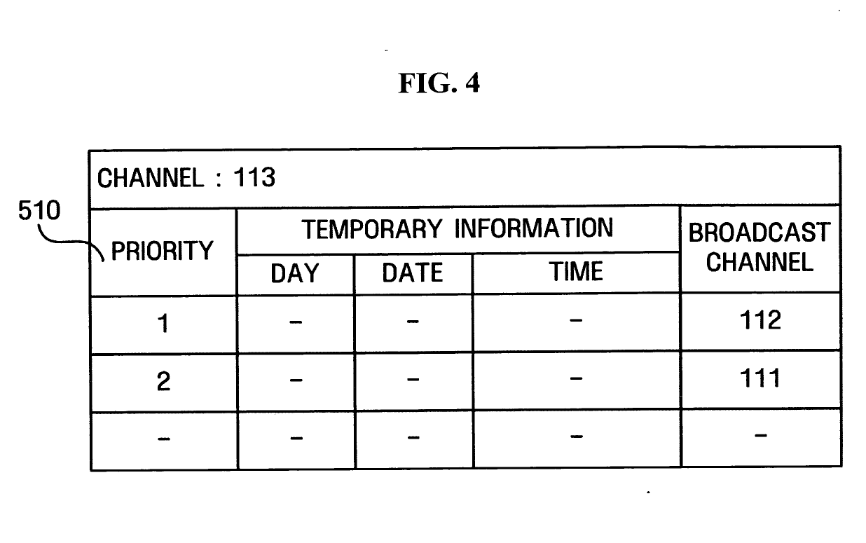

In the example described above, it has been described that channel numbers mapped to regular broadcast channels are set as broadcast channel information that constitutes a virtual channel, but the present invention is not limited to these examples, and channel numbers allocated to another virtual channel can be set as the broadcast channel information. For example, referring to the virtual channel illustrated in FIG. 4, the channel number allocated to the virtual channel is 113, and 111 and 112 are set as broadcast channel information. Hence, if the user selects virtual channel 113, then the broadcast channel is tuned according to the setting information of the virtual channel mapped to channel 112 and the virtual channel mapped to channel 111.

According to the present exemplary embodiment, in the case where a plurality of sets of broadcast channel information is set in a virtual channel, the priority of broadcast channels can be set. For example, as shown in FIG. 4, because virtual channel 112 is higher in priority than virtual channel 111, in the case where virtual channel 111 and virtual channel 112 include mutually-overlapped temporal information, the control unit 190 controls the channel tuning by giving priority to virtual channel 112 in overlapped time slots. If virtual channel 111 includes virtual-channel-setting information as illustrated FIG. 2, and virtual channel 112 includes virtual-channel-setting information as illustrated in FIG. 3, when virtual channel 113 is selected, it is possible that broadcast channels are tuned according to the setting information of virtual channel 112 on every Monday and Tuesday, and for the remaining days of the week, broadcast channels are tuned according to the setting information of virtual channel 111.

Referring to FIG. 1, the storage unit 180 stores virtual channels set by the virtual-channel-editing unit 170. For this, the storage unit 180 can include storage media such as a hard disk or a flash memory, but is not limited to these types of storage media. The storage media can manage the setting information of each virtual channel as well as the list of the stored virtual channels.

The control unit 190 controls the tuning unit 110 so that the requested channel is tuned. In the case where the requested channel is a regular broadcast channel, the control unit 190 can control the tuning of the requested channel as in a conventional art. However, if the requested channel is a virtual channel, the control unit 190 can control the tuning unit 110 by retrieving the virtual-channel-setting information stored in the storage unit 180 so that the channel is tuned according to the virtual-channel-setting information. Further, in the case where the user is watching a broadcast program by the selection of a virtual channel, the control unit 190 can control the tuning unit 110 so that the broadcast channel is changed according to the setting information of the virtual channel.

For example, in the situation where there is a virtual channel as illustrated in FIG. 2, if a selection request on virtual channel 111 is inputted, the control unit 190 retrieves temporal information corresponding to the current temporal information among temporal information of virtual channel 111, and can direct the tuning of the broadcast channel mapped to the retrieved temporal information. For example, if the input time of the selection request of virtual channel 111 is 22:00, the control unit 190 can control the tuning unit 110 so that broadcasting channel 7 is tuned. Then, if 23:00 passes by without a change of the channel, the control unit 190 controls the tuning unit 110 so that broadcasting channel 9 is tuned. This is because broadcast channel 9, among temporal information 210 of virtual channel 111, is mapped from 23:00 to 24:00.

According to the present exemplary embodiment, the broadcast-receiving device 100 can further include a timer (not shown) that provides current temporal information to be compared with temporal information of the virtual channel. For instance, such a timer can be included in the control unit 190.

The term “unit” as used in this exemplary embodiment refers to, for instance, a hardware element such as a Field Programmable Gate Array (FPGA) or an Application Specific Integrated Circuit (ASIC), and a “unit” executes certain functions. A “unit” can be constituted to exist in addressable storage media, or can be constituted to regenerate on one or more processors. For example, a “unit” can include software elements, object-oriented software elements, class elements, task elements, processes, functions, attributes, procedures, circuits, data, database, data structures, tables, arrays, and variables. Elements and functions provided in “units” can be combined into fewer elements or “units,” or can be divided into additional elements and “units.”

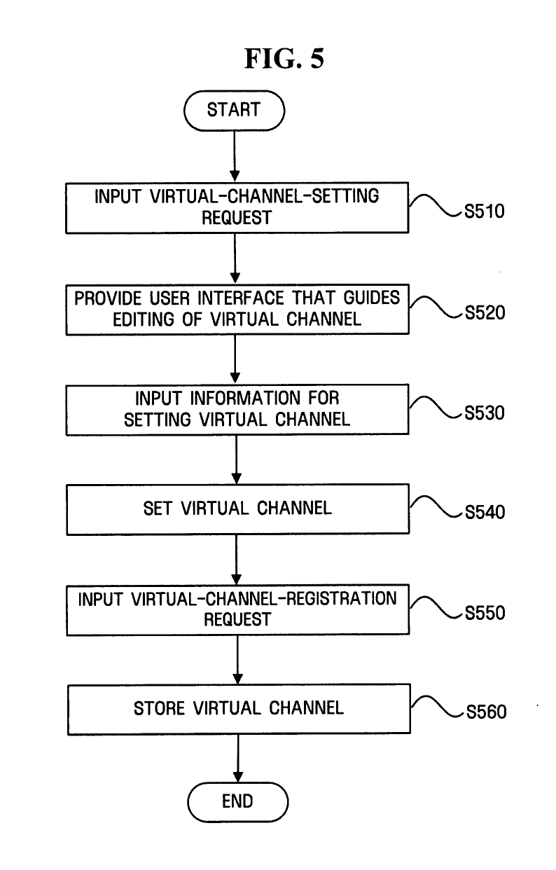

FIG. 5 is a flow chart illustrating a process of setting a virtual channel according to an exemplary embodiment of the present invention.

If the input unit 160 receives a virtual-channel-setting request from a user in operation S510, the virtual-channel-editing unit 170 provides a user interface that guides the editing of the virtual channel in operation S520. For example, the virtual-channel-editing unit 170 can provide a table-type user interface as illustrated in FIG. 2, FIG. 3 and FIG. 4.

The user can set a virtual channel by inputting desired temporal information, channel information, virtual channel number, or other information through the user interface. If the information to set the inputted virtual channel is inputted by the input unit 160 in operation S530, then the virtual-channel-editing unit 170 sets the virtual channel using the inputted information in operation S540.

Then, if the input unit 160 receives a virtual channel registration request in operation S550, then the storage unit 180 stores a virtual channel set by the virtual-channel-editing unit 170 in operation S560.

Exempting the process described above, a user, who is watching a certain broadcast, can include the current broadcast channel in a virtual channel. For this, the user can request to add virtual-channel-setting information using a predetermined function key of a remote control device or an input unit 160. According to an exemplary embodiment of the present invention, the virtual-channel-editing unit 170 can provide a predetermined user interface that guides the editing of the virtual channel. The user can select the virtual channel to add the broadcast channel that the user is currently watching as a component, and can set temporal information that indicates the broadcast time of the broadcast channel.

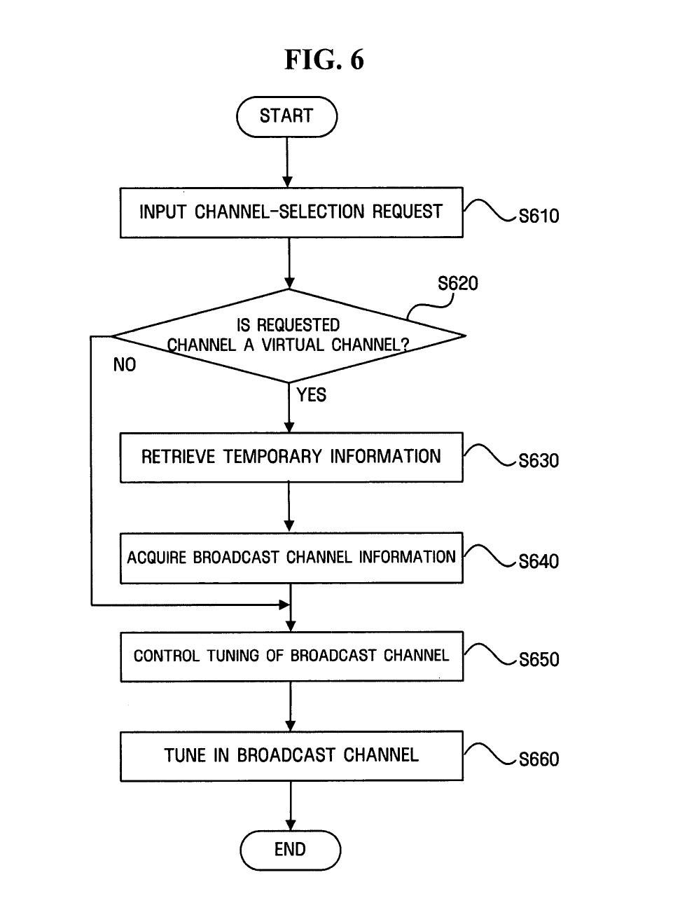

FIG. 6 is a flow chart illustrating a process of tuning a broadcast channel according to an exemplary embodiment of the present invention.

A user can request a channel selection by inputting a channel number mapped to a desired channel. If the input unit 160 receives a channel selection request of the user in operation S610, the control unit 190 determines whether the requested channel is a virtual channel in operation S620. Whether the requested channel is a virtual channel can be determined by referring to the list of virtual channels stored in the storage unit 180.

If the requested channel is not a virtual channel, the control unit 190 controls the tuning of the channel as in the conventional art in operation S650, and the tuning unit 110 can tune the broadcast channel according to the control of the control unit 190 in operation S660.

However, if the requested channel is a virtual channel, the control unit 190 retrieves temporal information, which corresponds to the current temporal information, from the setting information of the virtual channel corresponding to the requested channel in operation S630, and acquires broadcast channel information mapped to the retrieved temporal information in operation S640.

Then, the control unit 190 controls the tuning unit 110 so that the broadcast channel corresponding to the acquired broadcast channel information is tuned in operation S650, and the tuning unit 110 tunes the broadcast channel according to the control of the controlling unit 190 in operation S660.

The broadcast signal of the tuned broadcast channel is handled by the tuning unit 110, the demodulation unit 120, the demultiplexing unit 130, the decoding unit 140, and the output unit 150, and the user can view the broadcast program. Because a virtual channel is an independent channel, the user can perform a change of the channel between the general broadcast channel and the virtual channel.

Further, though not illustrated in FIG. 6, if a requested virtual channel includes another virtual channel as broadcast channel information among the setting information, the control unit 190 can retrieve the setting information of the virtual channel in the storage unit 180, and can control the tuning of the broadcast channel.

Further, as described above, if a certain virtual channel is selected, the control unit 190 can control the tuning unit 110 so that the broadcast channel is changed with the passage of time and according to the setting information of the virtual channel.

It should be understood by those of ordinary skill in the art that various replacements, modifications and changes may be made in the form and details without departing from the spirit and scope of the present invention as defined by the following claims. Therefore, it is to be appreciated that the above described exemplary embodiments are for purposes of illustration only and are not to be construed as limitations of the invention.

According to exemplary embodiments of the present invention, broadcast scheduling and channel selection become easy by using a virtual channel that can be directly set by the user.

What is claimed is:

1. A method of tuning a broadcast channel, the method comprising:
receiving a channel selection request; and
tuning the broadcast channel according to setting information of a virtual channel if the channel selection request comprises a request for the virtual channel, wherein the setting information comprises information regarding a predetermined time at which the broadcast channel is to be tuned.

2. The method of claim 1, further comprising tuning a broadcast channel that corresponds to the setting information of the virtual channel at the predetermined time.

3. The method of claim 1, wherein the virtual channel comprises a set of broadcast channel information, and temporal information to which the set of broadcast channel information is mapped.

4. The method of claim 3, wherein the tuning the broadcast channel comprises:
retrieving temporal information, which is mapped to a time when the channel-selection request is inputted, from among the temporal information comprising the virtual channel; and
tuning a broadcast channel that is mapped to the retrieved temporal information.

5. The method of claim 4, further comprising tuning the broadcast channel according to a predetermined priority order if the retrieved temporal information comprises plural sets of conflicting temporal information.

6. The method of claim 1, further comprising setting the virtual channel.

7. A broadcast-receiving device comprising:
an input unit that receives a channel selection request; and
a tuning unit that tunes a broadcast channel according to setting information of a virtual channel if the channel selection request comprises a request for the virtual channel, wherein the setting information comprises information regarding a predetermined time at which the broadcast channel is to be tuned.

8. The device of claim 7, wherein the tuning unit tunes a broadcast channel that corresponds to the setting information of the virtual channel at the predetermined time.

9. The device of claim 7, wherein the virtual channel comprises a set of broadcast channel information, and temporal information to which the set of broadcast channel information is mapped.

10. The device of claim 9, further comprising:
a storage unit that stores the setting information of the virtual channel; and
a control unit that retrieves temporal information, which is mapped to a time when the channel-selection request is inputted, from among the temporal information.

11. The device of claim 10, wherein the control unit controls the tuning unit so that the broadcast channel is tuned according to a predetermined priority if the retrieved temporal information comprises plural sets of conflicting temporal information.

12. The device of claim 7, further comprising a virtual channel setting unit.
